(19) United States
(12) Patent Application Publication
(10) Pub. No.: US 2005/0157962 A1
(43) Pub. Date: Jul. 21, 2005

(54) Linear guide apparatus

(75) Inventor: Jun Matsumoto, Fujisawa-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK LTD., Shinagawa-ku (JP)

(21) Appl. No.: 10/999,950

(22) Filed: Dec. 1, 2004

(30) Foreign Application Priority Data
Dec. 2, 2003 (JP) 2003-403,401
May 28, 2004 (JP) 2004-159,746

(51) Int. Cl. F16C 29/06

(52) U.S. Cl. 384/44

(57) ABSTRACT

A plurality of rollers of a linear guide apparatus roll on both rolling element raceway surfaces formed on a guide rail and a slider main body. The slider main body has chamfered portions formed by chamfering end portions of the rolling element raceway surfaces thereof and curved surfaced portions between the rolling element raceway surfaces and the chamfered portions. The curved surfaced portions are formed by grinding boundaries between the rolling element raceway surfaces and the chamfered portions into an arcuate shape with radius of curvature r_{L} that the ratio of the curvature r_{L} and the diameter D_{W} of the rollers r_{L}/D_{W}≧0.02 or more.

### BACKGROUND OF THE INVENTION

1. Field of the Invention

The present invention concerns a linear guide apparatus for guiding a linearly moving body such as a work table along the moving direction thereof and, more in particular, it relates to a linear guide apparatus using rollers as rolling elements.

2. Description of the Related Art

Linear guide apparatus used in various kinds of industrial machines such as machine tools include those using balls and those using rollers as rolling elements and linear guide apparatus of the latter type are usually used in a case where relatively high rigidity is required. The linear guide apparatus of this type comprises a guide rail, a slider including a slider main body and two end caps, and a plurality of rollers. The slider main body has rolling element raceway surfaces opposed to rolling element raceway surfaces formed on the guide rail along the longitudinal direction of the rail and rolling element return channels penetrated in the longitudinal direction of the guide rail. The end caps have communication channels for communication of the rolling element return channels and rolling element loading rolling channels formed between the rolling element raceway surfaces of the guide rail and the slider main body. The rollers roll through the rolling element loading rolling channels, the rolling element return channels and the communication channels, when the slider moves relatively in the longitudinal direction of the guide rail. The rollers are returned by way of the rolling element return channels and the communication channels to the rolling element loading rolling channels and roll along the paths circulatorily.

In the linear guide apparatus described above, assuming the distance between the rolling element raceway surfaces of the guide rail (hereinafter referred to as “rail side rolling element raceway surfaces”) and the rolling element raceway surfaces of the slider main body (hereinafter referred to as “slider side rolling element raceway surfaces”) as D_{G}, and the diameter of the rollers as D_{W}, the roller diameter D_{W} is made larger than the distance D_{G} in order to apply a preload to the rollers to obtain high rigidity. Further, for suppressing vibrations generated upon passage of the rolling elements in the slider constituted with the slider main body and the end caps (hereinafter referred to as “rolling element passage vibration”) or suppressing the lowering of the running life of the slider caused by stress concentration, a moderately inclined portion referred as a crowning portion is often formed on both longitudinal end portions of the rolling element raceway surfaces of the slider main body.

However, when a dimensional error exceeding a maximum fabrication depth of the crowning portion (10 to 30 μm) is caused between the slider main body and the end caps by shrinkage or the like which is formed upon resin molding of the end caps, in a case where the rollers going out of the communication channels of the end caps enter the rolling element loading rolling channels, the rollers abut against corner portions of the slider main body formed by the rolling element raceway surfaces and the end faces thereof to sometimes cause fatigue injury, etc. to the roller. Then, it has been known a linear guide apparatus in which a slider main body has chamfered portions (inclined portion) 13 formed by chamfering an end portion of rolling element raceway surfaces 7 thereof as shown in FIG. 25, thereby preventing the rollers going out of the communication channels of the end caps from colliding against the corner portions of the slider main body.

However, in a case where the slider main body has the chamfered portions 13 as shown in FIG. 25 formed on the both longitudinal ends of the slider side rolling element raceway surfaces 7, boundaries between the rolling element raceway surfaces 7 of the slider main body and the chamfered portion 13 forms a sharp edge shape. Accordingly, in the linear guide apparatus described above, the collision of the rollers going out of the communication channels of the end caps against the corner portions of the slider main body can be prevented, but the rollers that enter from the communication channels to the rolling element loading rolling channels abut against the boundaries between the rolling element raceway surfaces of the slider main body and the chamfered portions to possibly cause fatigue injury or the like to the roller. Particularly, in a case where the rolling element is a roller, since the area abutting against the boundaries between the rolling element raceway surfaces of the slider main body and the chamfered portions are larger compared with the case of the ball, fatigue injury or early wear tends to be caused to the roller as the rolling element.

By the way, in the linear guide apparatus described above, assuming the oversize amount of the rollers as δ₀ (=D_{W}−D_{G}), the elastic deformation amount δₑ of the roller elastically deformed in the rolling element loading rolling channels is often about from 0.2 to 0.4 times the over size amount δ₀. This is because the slider main body 5 elastically deforms as shown in FIG. 21. Accordingly, in a case where the oversize amount δ₀ is considerably larger compared with the elastic deformation amount δₑ, and the maximum reduction amount δₘₐₓ of a crowning portion 12 (refer to FIG. 26) is set to larger than the oversize amount δ₀, the length for the portion in the length L_{ct} of the crowning portion 12 that undergoes the load from the rollers 8 increases to sometimes lower the rigidity. Then, for overcoming the problem described above, Japanese Examined Utility Model Publication Hei 2-35051 and Japanese Examined Utility Model Publication Sho 56-50176 disclose those in which each of crowning portions formed on rolling element surfaces of a slider main body has an abruptly inclined portion that inclines greatly relative to the slider side rolling element raceway surfaces and a moderately inclined portion formed between the abruptly inclined portion and the slider side rolling element raceway surfaces.

However, in the linear guide apparatus disclosed in Japanese Examined Utility Model Publication Hei 2-35051, since recessed portions that change the size toward the longitudinal direction of the raceway surfaces are formed on the raceway surfaces, the shape of the raceway surfaces are complicated. Therefore, this makes the fabrication of the raceway surfaces difficult to result in a problem of increasing the fabrication cost. On the other hand, in the linear guide apparatus disclosed Japanese Examined Utility Model Publication Sho 56-50176, the effect concerning the rolling element passage vibrations which is important to the linear guide apparatus is not disclosed at all. Further, the range for the length of the moderately inclined portion and the abruptly inclined portion is only shown rather generally to bring about a possibility not capable of obtaining sufficient effect.

The present invention has been achieved taking notice on such problems and it intends to provide a linear guide apparatus capable of suppressing wear or fatigue injury to rollers as the rolling element. Further, the invention additionally intends to provide a linear guide apparatus capable of ensuring necessary rigidity even in a case of setting the maximum reduction amount of the crowning portion to more than the oversize amount of the rollers.

### SUMMARY OF THE INVENTION

The present invention provides in the first aspect thereof, a linear guide apparatus comprising a guide rail, a slider including a slider main body having rolling element raceway surfaces opposed to rolling element raceway surfaces formed on the guide rail along the longitudinal direction of the rail and rolling element return channels penetrated in the longitudinal direction of the guide rail and end caps having communication channels for communication of the rolling element return channels and rolling element loading rolling channels formed between both of the rolling element raceway surfaces of the guide rail and the slider main body, and a plurality of rollers that roll through the rolling element loading rolling channels, the rolling element return channels and the communication channels, wherein
the slider main body has chamfered portions inclined obliquely to the slider side rolling element raceway surfaces on both longitudinal end portions of the slider side rolling element raceway surface, the chamfered portions and the slider side rolling element raceway surfaces are formed by grinding a boundary between the slider side rolling element raceway surfaces and the chamfered portions into an arcuate shape, and are connected smoothly by way of curved surface portions with a ratio of the radius of curvature relative to the diameter of the roller being 0.02 or more.

The present invention provides, in the second aspect thereof, a linear guide apparatus comprising a guide rail, a slider including a slider main body having rolling element raceway surfaces opposed to rolling element raceway surfaces formed on the guide rail along the longitudinal direction of the rail and rolling element return channels penetrated in the longitudinal direction of the guide rail and end caps having communication channels for communication of the rolling element return channels and rolling element loading rolling channels formed between both of the rolling element raceway surfaces of the guide rail and the slider main body, and a plurality of rollers that roll through the rolling element loading rolling channels, the rolling element return channels and the communication channels, wherein
the slider main body has crowning portions on both longitudinal end portions of the slider side rolling element surfaces, the crowning portions respectively include an abruptly inclined portion that inclines greatly to the slider side rolling element surfaces and a moderately inclined portion formed between the abruptly inclined portion and the slider side rolling element surfaces, and the crowning portions have a ratio of the effective length relative to the diameter of the roller being 1 or more.

In the linear guide apparatus according to the first aspect of the invention, the chamfered portions are preferably formed to both longitudinal end portions of the slider side rolling element raceway surfaces at an angle of inclination of 10° or more and 45° or less relative to the slider side rolling element raceway surfaces.

Further, the curved surface portions may be formed after the grinding of the slider side rolling element raceway surfaces or simultaneously with the grinding for the slider side rolling element raceway surfaces.

Further, the slider main body may have crowning portions formed by fabricating both longitudinal end portions of the slider side rolling element raceway surfaces such that each of both longitudinal end portions of the rolling element loading rolling channels are gradually diverged toward the communication channels.

In the linear guide apparatus according to the second aspect of the invention, the moderately inclined portion is preferably formed between the abruptly inclined portion and the slider side rolling element raceway surfaces at a radius of curvature with a ratio relative to the diameter of the rollers being 1000 or more.

Further, the moderately inclined portion is preferably formed between the abruptly inclined portion and the slider side rolling element raceway surfaces at an angle of inclination with the gradient to the slider side rolling element raceway surfaces being 1/2000 or less.

Further, the abruptly inclined portion preferably has a ratio of the length relative to the diameter of the rollers of 0.5 or more

### BRIEF DESCRIPTION OF THE DRAWINGS

FIG. 1 is a perspective view of a linear guide apparatus according to a first embodiment of the present invention;

FIG. 2 is a front elevational view of the linear guide apparatus shown in FIG. 1;

FIG. 3 is a cross sectional view taken along line III-III in FIG. 2;

FIG. 4 is a cross sectional view taken along line IV-IV in FIG. 2;

FIG. 5 is a cross sectional view along the longitudinal direction of a slider side rolling element raceway surface shown in FIG. 3 and FIG. 4;

FIG. 6 is an explanatory view for explaining an example of a method of forming a curved surface portion formed between the rolling element raceway surface of the slider main body and a chamfered portion thereof shown in FIG. 5;

FIG. 7 is a graph showing a relation between the ratio of radius of curvature at the curved surface portion relative to the diameter of rollers (r_{L}/D_{W}), and a maximum contact pressure of the rollers (Pₘₐₓ);

FIG. 8 is an explanatory view for explaining another example of a method of forming the curved surface portion;

FIG. 9 is an explanatory view for explaining another example of a method of forming the curved surface portion;

FIG. 10 is a cross sectional view showing a main portion of a linear guide apparatus according to a second embodiment of the invention;

FIG. 11 is a perspective view of a linear guide apparatus according to a third embodiment of the present invention;

FIG. 12 is a front elevational view of the linear guide apparatus shown in FIG. 11;

FIG. 13 is a cross sectional view taken along XIII-XIII in FIG. 12;

FIG. 14 is a cross sectional view along the longitudinal direction of the slider side rolling element raceway surface shown in FIG. 12;

FIG. 15 is a view showing a pitching displacement measuring apparatus used upon measuring a pitching displacement of a slider;

FIG. 16 is a graph showing a relation between the ratio of radius of curvature of a moderately inclined portion relative to a roller diameter and a pitch displacement of a slider;

FIG. 17 is a graph showing a relation between the ratio of the length for an abruptly inclined portion relative to the roller diameter and the rigidity of the slider;

FIG. 18 is a view showing a relation between the ratio of the length for the abruptly inclined portion relative to the diameter of the roller and the angle of inclination of the abruptly inclined portion relative to the raceway surfaces of the slider main body;

FIG. 19 is a cross sectional view showing a main portion of a linear guide apparatus according to a fourth embodiment of the invention;

FIG. 20 is a graph showing a relation between the pitching displacement of a slider and the angle of inclination of a moderately inclined portion;

FIG. 21 is a view for explaining the effect of a load applied from a roller to a slider main body;

FIG. 22 is a graph showing a relation between the amount of preload on the roller and the oversize amount of the roller;

FIG. 23 is a graph showing a relation between the effective length ratio of a crowning portion relative to the diameter of a roller and the pitching displacement of a slider;

FIG. 24 is a graph showing a relation between the effective length ratio of a crowning portion relative to the roller of diameter and a pitching displacement of the slider;

FIG. 25 is a view showing a chamfered portion formed on both longitudinal ends of a slider side rolling element raceway surface; and

FIG. 26A and FIG. 26B are views each showing the shape of a crowning portion formed on both longitudinal ends for the slider side rolling element raceway surface.

### DESCRIPTION OF THE PREFERRED EMBODIMENTS

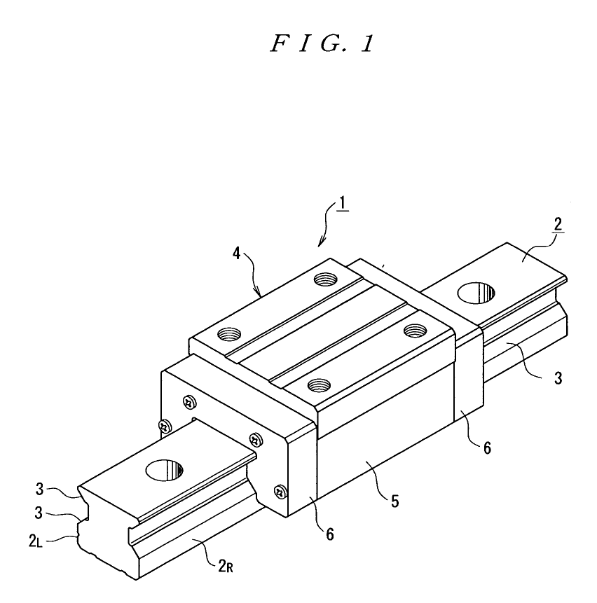

A first embodiment according to the present invention is to be described with reference to FIG. 1 to FIG. 5.

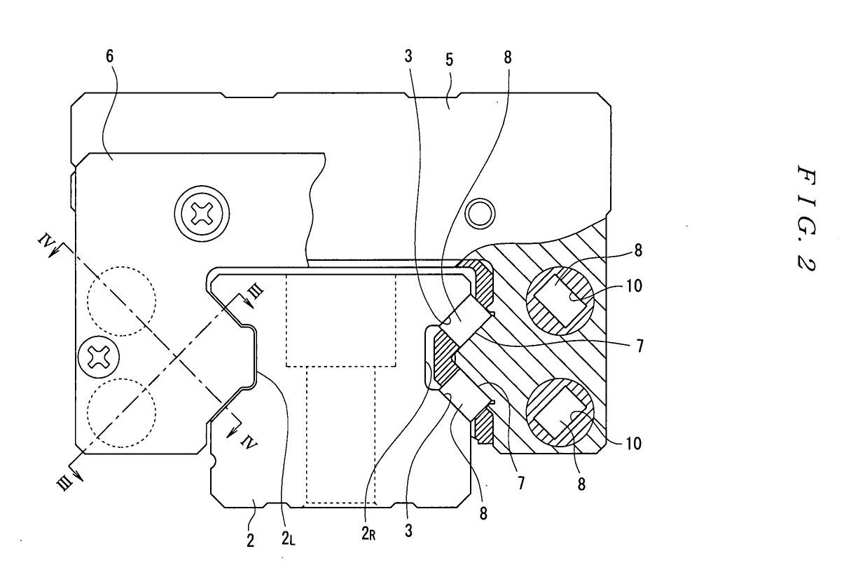

In FIG. 1 and FIG. 2, a linear guide apparatus 1 according to the first embodiment of the invention comprises a guide rail 2, a slider 4 and plural rollers 8 as rolling elements. The guide rail 2 is formed in a linear shape, and has four rolling element raceway surfaces (hereinafter referred to as “rail side rolling element raceway surfaces”) 3. The rail side rolling element raceway surfaces 3 are formed on a lateral left surface 2_{L} and a lateral right surfaces 2_{R} of the guide rail 2, each by two along the longitudinal direction of the guide rail 2.

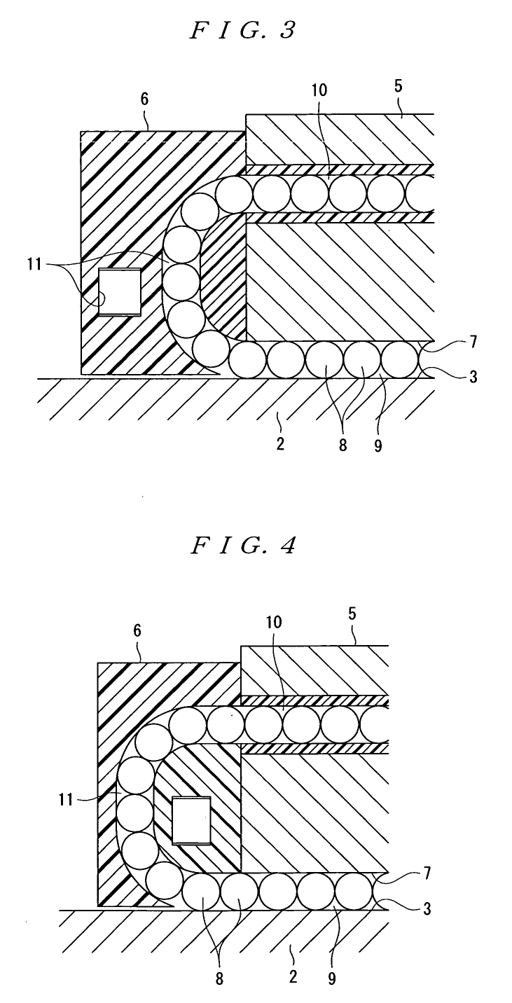

A slider 4 includes a slider main body 5 and two end caps 6. The slider main body 5 has four rolling element raceway surfaces (hereinafter referred to as “slider side rolling element raceway surfaces”) 7 and four rolling return channels 10. The slider side rolling element raceway surfaces 7 are opposed respectively to the rail side rolling element raceway surfaces 3 (refer to FIG. 2). Rolling element loading rolling channels 9 are formed between the rail side rolling element raceway surfaces 3 and the slider side rolling element raceway surface 7 for rolling the rollers 8 in the longitudinal direction of the guide rail 2 (refer to FIG. 3 and FIG. 4). The end caps 6 are fixed on opposite end faces of the slider main body 5, and has four communication channels 11.

The rollers 8 are adapted to roll along the rolling element loading rolling channels 9 when the slider 4 moves relatively in the longitudinal direction of the guide rail 2. The rolling element return channels 10 are formed in the slider main body 5 corresponding to the rolling element loading channels 9 for returning the rollers 8 (refer to FIG. 3 and FIG. 4).

The rolling element return channels 10 of the slider main body are penetrated in the longitudinal direction of the guide rail 2. The communication channels 11 of the end caps 6 are communicated to the rolling element loading rolling channels 9 and the rolling element return channels 10. The communication channels 11 are curved substantially into a U-shaped configuration in order to change the rolling direction of the rollers 8 that have passed the rolling element loading rolling channel 9 or the rolling element return channel 10.

Each of the rolling element raceway surfaces 7 of the slider main body 5 has two crowning portions 12 at both longitudinal end portions thereof. The crowning portions 12 control the load applied from the rolling element loading rolling channel 9 to the roller 8 (refer to FIG. 5). The crowning portions 12 are formed by grinding the both longitudinal end portions of the rolling element raceway surfaces 7 of the slider main body such that both longitudinal end portions of the rolling element loading rolling channel 9 are gradually diverged toward the communication channels 11 of the end caps 6. The slider main body 5 has eight chamfered portions (inclined surface portions) 13 formed by chamfering an end portion of the rolling element surfaces 7 thereof. The chamfered portions 13 are inclined obliquely relative to the slider side rolling element raceway surfaces 7.

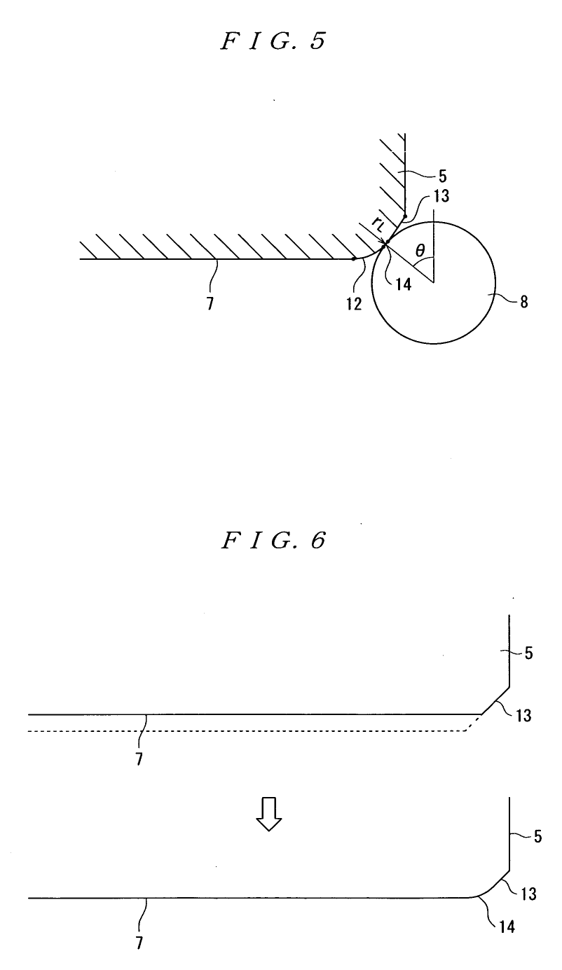

The chamfered portions 13 are inclined relative to the slider side rolling element raceway surfaces 7 at an angle of 10° or more and 45° or less. The slider main body 5 has eight curved surface portions 14 formed between the chamfered portions 13 and the rolling element raceway surfaces 7 thereof (refer to FIG. 5). The curved surface portions 14 are formed into an arcuate shape such that the chamfered portions 13 are smoothly connected to the raceway surfaces 7 of the slider main body 5. The portions 14 are formed, for example, as shown in FIG. 6 by grinding the slider side rolling element raceway surfaces 7 and then grinding boundaries between the sliding side rolling element raceway surfaces 7 and the chamfered portions 13 by a rubber honing stone into an arcuate shape. The curvature r_{L} for the curved surface portions 14 is defined as: r_{L}/D_{W}≧0.02 where D_{w} is the diameter for the rollers 8.

In the constitution described above, assuming the revolutional speed of the rollers 8 as V_{E}, the velocity component of the rollers 8 vertical to the colliding surface as V_{EN}, the angle of contact of the rollers 8 in contact with the curved surface portions 14 as θ (refer to FIG. 5) and the elastic deformation amount of the rollers 8 between the rolling element raceway surfaces 3, 7 of the rail 2 and the slider main body 5 as δₑ, the relation defined by the following equations (1) and (2) is established:
V_{EN}=V_{E}·sin θ (1)
(D_{w}(1−cos θ))/2=δₑ (2)

Since δₑ/D_{W} is a sufficiently small value, the following equation is obtained from the equation (2).

$$\begin{matrix}sin θ = \sqrt{} ( 1 - {cos}^{2} θ ) \\ = \sqrt{} ( 1 - ( 1 - {( 2 {δ}_{e /} {D}_{W} )}^{2} ) ) \approx \sqrt{} ( 4 {δ}_{e /} {D}_{W} )\end{matrix} \qquad ( 3 )$$

In a case where the rolling element is a roller, the relation of the following equations is established between the load Q on the rolling element and the elastic deformation amount δₑ or the rolling element;
δ_{c}=k_{P}(Q^{0.9}/L_{we}^{0.8})
or Q=(δₑ/k_{P})^{10/9}·L_{we}^{8/9} (4)
k_{P}: constant (=3.84×10⁻⁵ mm^{1.8}/N^{0.9})

According to the energy conservation law, since the kinetic energy before collision=work required for elastic deformation, the following equation is established. While losses such as conversion into thermal energy exist in the strict sense. they are substantially negligible.

$$\frac{1}{2} {mv}_{EN}^{2} = {\int }^{{Δ}_{max}} Q ⅆ δ = \frac{9}{19} \frac{{L}_{we}^{\frac{8}{9}}}{{k}_{p}^{\frac{10}{9}}} {Δ}_{max}^{\frac{19}{9}} \qquad ( 5 )$$

In the equation (5), m represents the mass of the roller 8, Δₘₐₓ represents the maximum deformation amount of the rollers at a portion in contact with the slider side rolling element raceway surfaces 7, and Δₘₐₓ is represented by the following equation according to the equation (5):

$${Δ}_{max} = {\{ \frac{19}{18} {mv}_{EN}^{2} \frac{{k}_{p}^{\frac{10}{9}}}{{L}_{we}^{\frac{8}{9}}} \}}^{\frac{9}{19}} \qquad ( 6 )$$

Assuming the maximum load Qₘₐₓ resulted to a contact portion between the rollers 8 and the slider side rolling raceways surfaces 7 as Qₘₐₓ, the maximum load Qₘₐₓ is represented by the following equation according to the equations (4) and (6):

$${Q}_{max} = {\{ \frac{19}{18} \frac{{mv}_{EN}^{2}}{{k}_{p}} \}}^{\frac{10}{19}} {L}_{we}^{\frac{8}{19}} \qquad ( 7 )$$

Further, assuming the material coefficient determined by the material of the rollers 8 and the slider side rolling element raceway surfaces 7 as E_{eq}, and the maximum contact pressure of the rollers 8 resulted in the contact portion with the slider side rolling element raceway surfaces 7 as Pₘₐₓ, the maximum contact pressure Pₘₐₓ is represented by the following equation according to the Hertz's theory of elastic contact:

$${P}_{max} = \sqrt{\frac{{E}_{eq} {Q}_{max}}{2 π {L}_{we} \sum ρ}} \qquad ( 8 )$$

In the equation (8), Σ_{ρ} represents the sum for the radius of curvature in the contact portion, and the sum for radius Σ_{ρ} is represented by the following equation in a case where the rolling element is a roller:

$$\sum ρ = \frac{2}{{D}_{W}} + \frac{1}{{r}_{L}} \qquad ( 9 )$$

According to the equations (7) to (9), the maximum contact pressure Pₘₐₓ is represented by the following equation.
Pₘₐₓ=\sqrt{E}_{eq}/2 π L_{WB}[19 mv_{EK}²/18 kₚ]^{10/19}L_{we}^{8/19} 1/D_{w}[2+1/r_{L}/D_{w}]

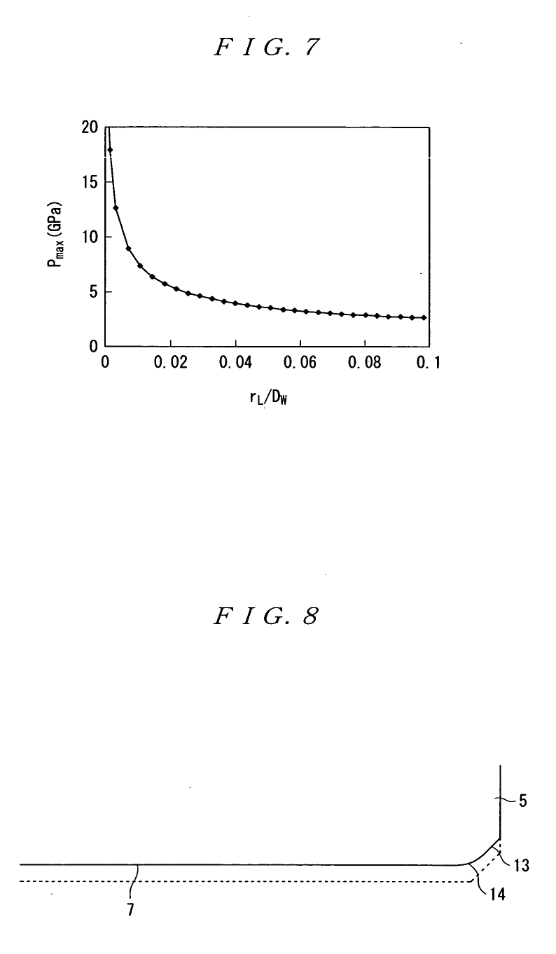

FIG. 7 shows the result of calculation for the relation between r_{L}/D_{w} and Pmax according to the equation (10), assuming roller diameter as: D_{w}=5.5 mm, roller entire length as: L_{wt}=8 mm, roller chamfered length as: C_{w}=0.3 mm, roller effective length (length obtained by removing the roller chamfered length from the roller entire length) as: L_{we}=L_{WL}−2C_{W}=7.4 mm, roller material as bearing steel, raceway surface material as bearing steel, E_{eq}=230000 N/m², roller mass as: m=4.4.×10⁻⁴ kg, roller revolutional velocity as: V_{E}=1000 mm/s, roller elastic deformation amount as: δₑ=0.005 mm, fabrication amount for curved surface portions 14 as: C_{L}=0.3 mm, with the radius of curvature for the curved face portions 14 being changed within a range of r_{L}/D_{W}=0.001 to 0.1.

It can be seen from the result of the calculation shown in the drawing that, while the maximum contact pressure Pₘₐₓ of the rollers 8 increases abruptly when the ratio of the radius of curvature (r_{L}/D_{W}) of the curved surface portions 14 to the diameter of the rollers 8 is lower than 0.02, the maximum contact pressure Pₘₐₓ of the rollers 8 can be suppressed when the ratio of ratio of radius of curvature (r_{L}/D_{W}) for the curved surface portions 14 relative to the diameter of the rollers 8 is 0.02 or more. It can be seen that when ratio of the radius of curvature (r_{L}/D_{W}) of the curved surface portions 14 to the diameter of the rollers 8 is 0.04 or more, the maximum contact pressure Pₘₐₓ of the rollers 8 can be supposed particularly.

Accordingly, by defining the radius of curvature r_{L} for the curved surface portions 14 formed by grinding the boundary portion between the slider side rolling element raceway surfaces 7 and the chamfered portions 13 into an actuate shape as: r_{L}/D_{W}≧0.02 relative to the diameter D_{w} of the rollers 8 since the contact pressure of the rollers 8 to the curved surface portions 14 can be suppressed, occurrence of early wear or fatigue injury to the rollers 8 as the rolling elements can be suppressed.

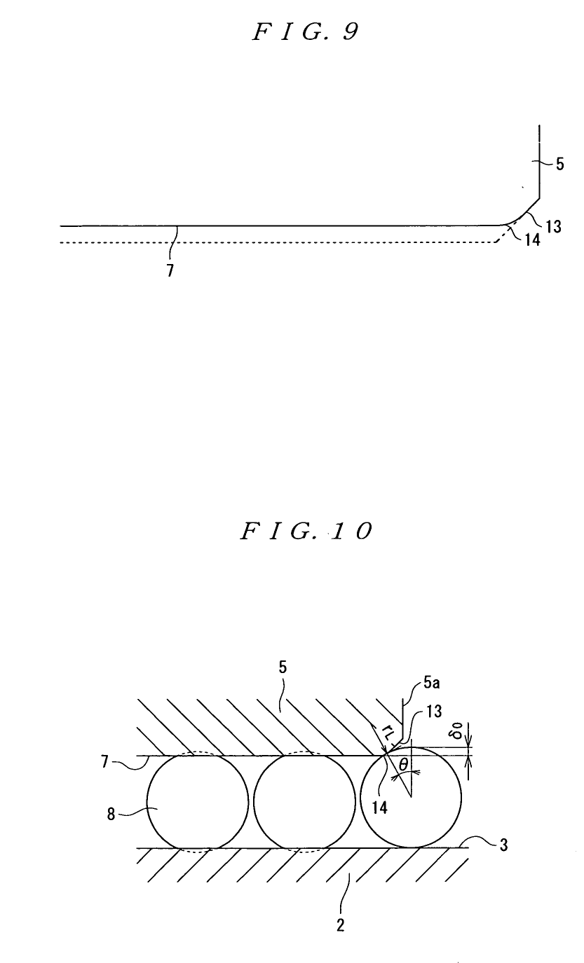

In the embodiment described above, while the curved surface portions 14 are formed by grinding the slider side rolling element raceway surfaces 7 and then grinding the boundary portion between the slider side rolling element raceway surfaces 7 and the chamfered portions 13 with a rubber honing stone or the like, the curved surface portions 14 may also be formed simultaneously with the grinding for the slider side rolling element raceway surfaces 7 as shown in FIG. 8. Further, while the curved surface portions 14 are formed after forming the chamfered portions 13 by the method shown in FIG. 8, the chamfered portions 13 and the curved surface portions 14 may be formed simultaneously as shown in FIG. 9.

Further, in the first embodiment, the rolling element raceway surfaces 7 of the slider main body 5 have two crowning portions 12 respectively, the present invention is not limited thereto but it will be apparent that the invention is applicable also to a linear guide apparatus not having crowing portions 12 on both longitudinal ends of the slider side rolling element raceway surfaces 7 as in a second embodiment shown in FIG. 10.

A third embodiment according to the present invention is to be described with reference to FIG. 11 to FIG. 14.

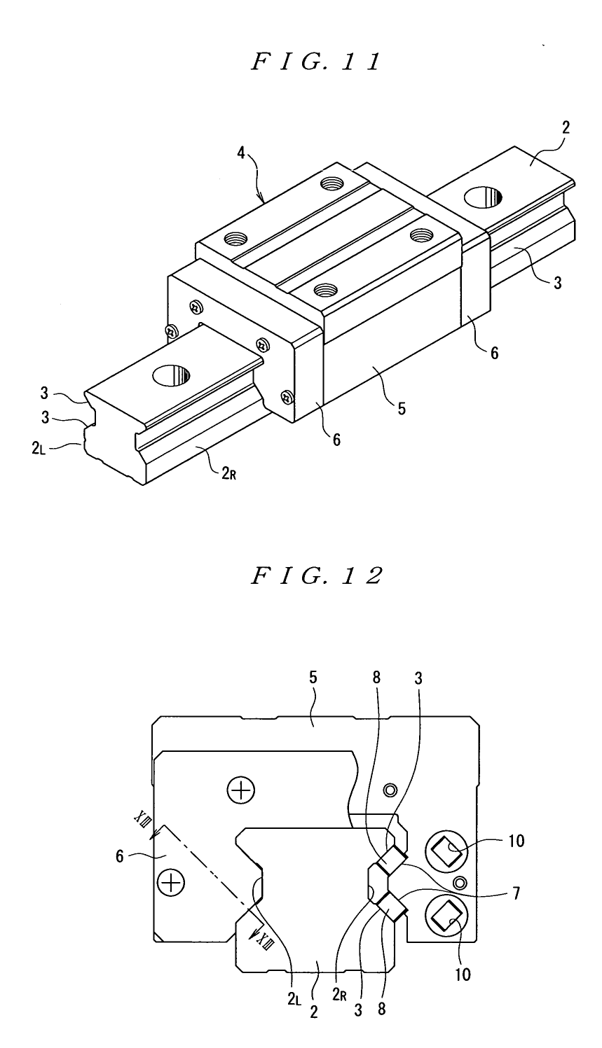

In FIG. 11 and FIG. 12, a linear guide apparatus according to the third embodiment of the invention comprises a guide rail 2, a slider 4 and plural rollers 8 as rolling elements. The guide rail 2 is formed in a linear shape, and has four rolling element raceway surfaces (hereinafter referred to as “rail side rolling element raceway surface”) 3. The rail side rolling element raceway surfaces 3 are formed on a lateral left surface 2_{L} and a lateral right surfaces 2_{R} of the guide rail 2, each by two along the longitudinal direction of the guide rail 2.

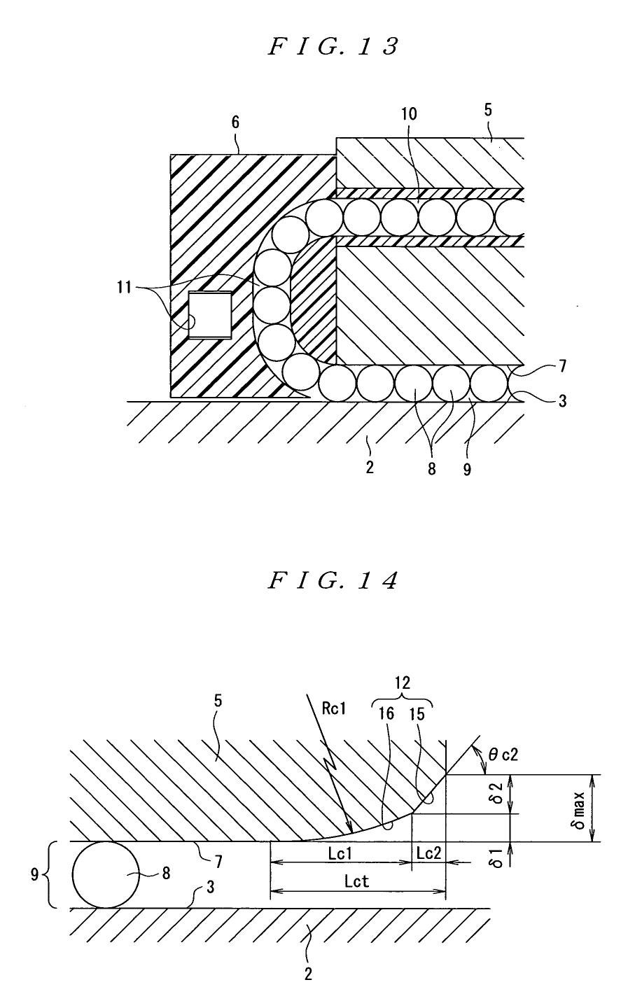

The slider 4 includes a slider main body 5 and two end caps 6. The slider main body 5 has four rolling element raceway surfaces (hereinafter referred to as “slider side rolling element raceway surface”) 7 and four rolling element return channels 10. The slider side rolling element raceway surfaces 7 are opposed respectively to the rail side rolling element raceway surfaces 3 (refer to FIG. 12). Rolling element loading rolling channels 9 are formed between the rail side rolling element raceway surface 3 and the slider side rolling element raceway surface 7 in order to roll the rollers 8 in the longitudinal direction of the guide rail 2 (refer to FIG. 13). The end caps 6 are fixed on opposite end faces of the slider main body, and have four communication channels 11, respectively.

The rollers 8 are adapted to roll along the rolling element loading rolling channels 9 when the slider 4 moves relatively in the longitudinal direction of the guide rail 2, and a rolling element return channel 10 is formed in the slider main body 5 corresponding to the rolling element loading channel 9 for returning the rollers 8 that have rolled along the rolling element loading rolling channel 9 (refer to FIG. 13).

The rolling element return channels 10 formed in the slider main body are penetrated in the longitudinal direction of the guide rail 2. The communication channels 11 of the end caps 6 are communicated to the rolling element loading rolling channels 9 and the rolling element return channels 10. The communication channels 11 are curved substantially into a U-shaped configuration in order to change the rolling direction of the rollers 8 that have passed the rolling element loading rolling channels 9 or the rolling element return channels 10.

Each of the rolling element raceway surfaces 7 of the slider main body 5 has two crowning portions 12 at both longitudinal end portions thereof in order to control the load applied from the rolling element loading rolling channels 9 to the rollers 8 (refer to FIG. 14). The crowning portions 12 are formed by grinding the end portions of the slider side rolling element raceway surfaces 7 such that each of the both longitudinal end portions of the rolling element rolling loading rolling channels 9 is gradually diverged toward the communication channels 11 of the end caps 6. Assuming the diameter of the rollers 8 as D_{W}, the effective length L_{ce} of the crowning portions 12 is a length capable of satisfying: L_{ce}/D_{w}≧1.

The crowning portions 12 include a moderately inclined portion 16 adjoining to a non crowning portion of the rolling element raceway surfaces 7 of the slider main body 5 and an abruptly inclined portion 15 inclined greatly more than the moderately inclined portion 16, respectively. The abruptly inclined portion 15 is inclined greatly to the rolling element raceway surfaces 7 of the slider main body 5. The abruptly inclined portion 15 is formed adjacently to the moderately inclined portion 16 with a length L_{c}2 capable of satisfying: L_{c}2/D_{W}≧0.5. The moderately inclined portion 16 is formed between the abruptly inclined portion 15 and the rolling element surfaces 7 of the slider main body 5. The moderately inclined portion 16 is formed into an arcuate shape with a radius of curvature R_{c}1 satisfying: 1/θ_{c}1≧2000.

With the constitution described above, assuming the entire length of the crowning portions 12 as L_{ct}, the length of the moderately inclined portion 16 as L_{c}1, the length of the abruptly inclined portion 15 as L_{c}2, the maximum reduction amount of the crowning portions 12 as δₘₐₓ, the reduction amount of the moderately inclined portion 16 as δ1, the reduction amount of the abruptly inclined portion 15 as δ2, and the angle of inclination of the abruptly inclined portion 15 as θ_{c}2, the length L_{c}2 and the reduction amount θ2 and the angle of inclination θ_{c}2 of the abruptly inclined portion 15 can be determined according to the following equations.
L_{c}2=L_{ct}−L_{c}1 (11)
δ2=δₘₐₓ−δ1 (12)
θ_{c}2=δ2/L_{c}2 (13)

Further, assuming the radius of curvature of the moderately inclined portion 16 as R_{c}1, the effective length of the moderately inclined portion 16 as L_{ce}1 (≈L_{c}1), and the effective length of the abruptly inclined portion 15 as L_{ce}2 (≈L_{c}2), the length L_{c}1 of the moderately inclined portion 16 and the effective length L_{ce} of the crowning portions 12 can be determined according to the following equations:
L_{c}1=√(R_{c}1·δ1) (14)
L_{ce}=L_{ce}1+L_{ce}2 (15)

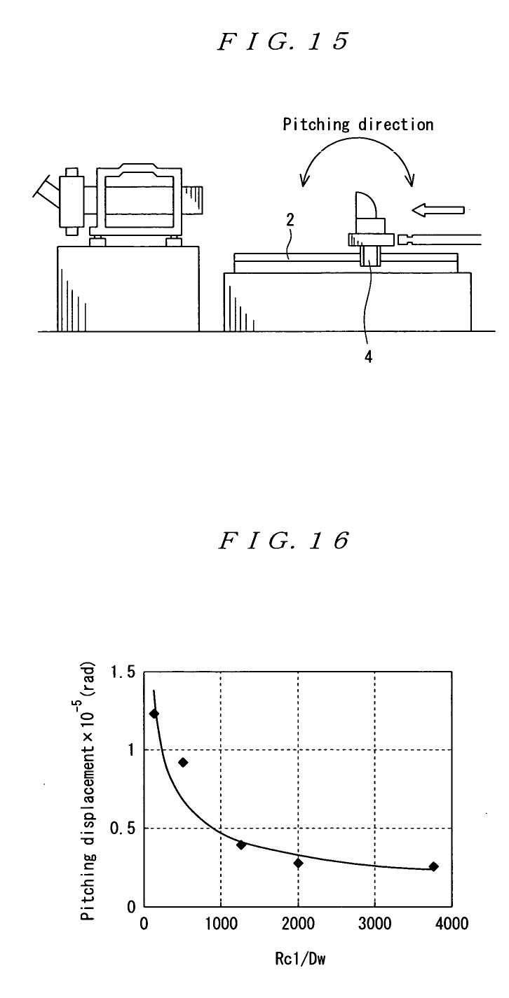

In the constitution described above, the displacement of the slider 4 when pitched in the direction shown by the arrow in FIG. 15 was measured while setting the slider side raceway surface length as: 80 mm, the rolling element diameter as: D_{W}=4 mm, the rolling element length as: 6 mm, the oversize amount of the rolling element as: δ₀:=0.01 mm, the maximum reduction amount of drowning as: δₘₐₓ=0.02 mm (ensuring a value larger than the oversize amount δ₀), the entire length of the crowning portions as: L_{ct}=L_{c}1+L_{c}2, the reduction amount of the moderately inclined portion as: δ1=0.005 mm, the reduction amount of the abruptly inclined portion as: δ2=δₘₐₓ−δ1=0.015 mm, the angle of inclination of abruptly inclined portion as: θ_{c}2=δ2/L_{c}2, and the length for the abruptly inclined portion: L_{c}2=2 mm.

Then, the magnitude of the rolling element passage vibrations in a case of changing the radius of curvature R_{c}1 of the moderately inclined portion 16 within a range of: R_{c}1/D_{W}=100 to 4000 (pitching displacement of slider) was determined by numerical value simulation. FIG. 16 shows a relation between the result of calculation and R_{c}1/D_{W}. The method of numerical simulation for the pitching of the slider is described in “NSK technical Journal No. 669 (2000) p 42 to 49”.

As apparent from FIG. 16, it can be seen that while the pitching displacement of the slider increases abruptly when the ratio of the radius of curvature of the moderately inclined portion 16 relative to the diameter of the roller 8 (R_{c}1/D_{W}) is less than 1000, the pitching displacement is 0.5×10⁻⁵ rad or less when the ratio of the radius of curvature of the moderately inclined portion 16 relative to the diameter of the roller 8 (R_{c}1/D_{W}) is 1000 or more, preferably, 1400 or more. Accordingly, since the pitching displacement of the slider is decreased by defining the ratio of the radius of curvature of the moderately inclined portion 16 relative to the diameter of the roller 8 (R_{c}1/D_{W}) to 1000 or more and, preferably, 1400 or more, the amplitude value of the rolling element passage vibrations can be retracted to a small value.

Further, in the embodiment described above, since the reduction amount of the crowning portion 12 can be ensured sufficiently by defining the maximum reduction amount δₘₐₓ (=0.020 mm) of the crowning portion 12 to the oversize amount δ₀ of the roller 8 (=0.01 mm) or more, the slider can be assembled easily to the guide rail.

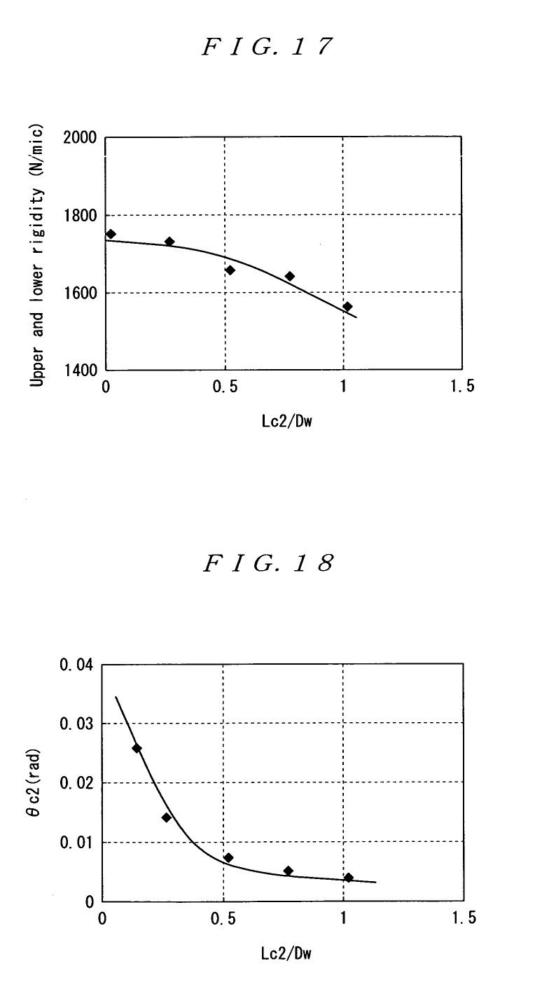

Then, FIG. 17 shows the result of calculation for the magnitude of upper and lower rigidity of the slider in a case of setting the slider side raceway surface length as: 80 mm, the rolling element diameter as: D_{W}=4 mm, the rolling element length as: 6 mm, the oversize amount of the rolling element as: δ₀=0.01 mm, the maximum reduction amount of the crowning as: δₘₐₓ=0.02 mm, the entire length of the crowning portion as: L_{ct}=L_{c}1+L_{c}2, the reduction amount of the moderately inclined portion as: δ1=0.005 mm, the reduction amount of the abruptly inclined portion as: δ2=δₘₐₓ−δ1=0.015 mm, the angle of inclination of the abruptly inclined portion as: θ_{c}2=ι2/L_{c}2, the radius of curvature of the moderately inclined portion 16 as: R_{c}1=4000 mm, and changing the length L_{c}2 of the abruptly inclined portion 15 as within a range L_{c}2/D_{W} of from 0.05 to 1.05.

As apparent from the result of calculation shown in FIG. 17, as the length L_{c}2 of the abruptly inclined portion 15 is longer, the rigidity of the slider decreases. Only with reference to the result, smaller length L_{c}2 is preferred for the abruptly inclined portion 15 but, when the length L_{c}2 of the abruptly inclined portion 15 is too small, assembling of the slider 4 to the guide rail 2 is difficult since resistance is too large, and the resistance upon assembling the slider 4 to the guide rail 2 is larger as the inclination θ_{c}2 of the inclined portion 15 is larger (that is, as the slope or gradient is more abrupt).

FIG. 18 shows a relation between ratio of the length of the abruptly inclined portion 15 relative to the diameter D_{W} of the roller 8 (L_{c}2/D_{W}) and the angle of inclination θ_{c}2 of the abruptly inclined portion 15. As apparent from the graph, the angle of inclination θ_{c}2 of the abruptly inclined portion 15 is smaller as the length L_{c}2 of the abruptly inclined portion 15 is larger, the angle of inclination θ_{c}2 is smaller as the ratio of the length L_{c}2 of the abruptly inclined portion 15 relative to the diameter D_{W} of the roller 8 (L_{c}2/D_{W}) is 0.5 or more. Further, as apparent from FIG. 17, since the rigidity of the slider increases as the length L_{c}2 of the abruptly inclined portion 15 is smaller, it is preferred that the ratio of the length L_{c}2 of the abruptly inclined portion 15 relative to the diameter D_{W} of the roller 8 (L_{c}2/D_{W}) is about 0.5.

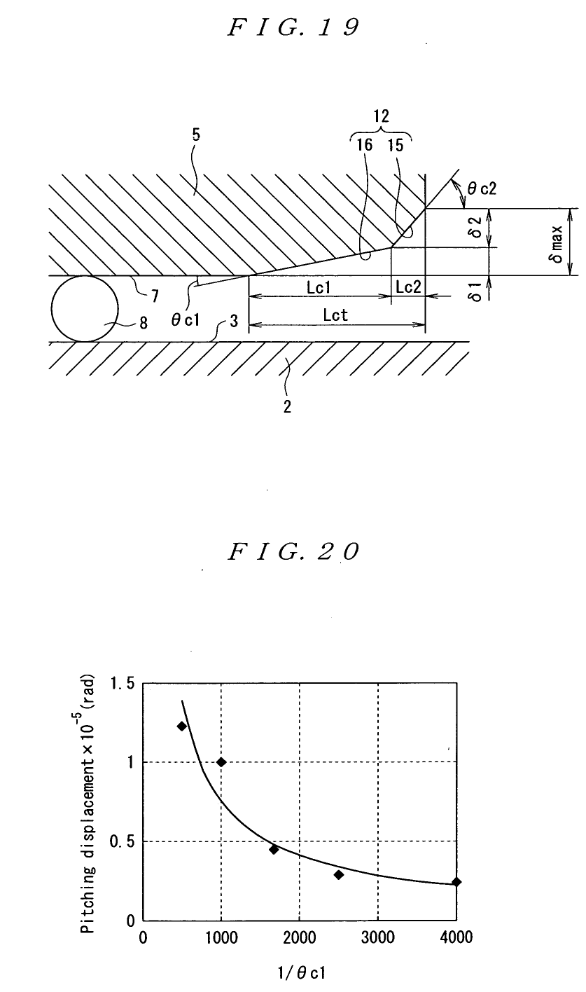

Then, FIG. 19 shows a main portion of a fifth linear guide apparatus according to the invention. As shown in the drawing, rolling element raceway surfaces 7 of a slider main body 5 have two crowning portions 12, respectively. The crowning portions 12 are provided at longitudinal end portions of the rolling element raceway surfaces 7, and include a moderately inclined portion 16 adjoining to a non crowning portion of the rolling element raceway surfaces 7 of the slider main body 5 and an abruptly inclined portion 15 inclined greatly more than the moderately inclined portion 16, respectively.

Assuming the length of the moderately inclined portion 16 as L_{c}1, the reduction amount of the moderately inclined portion 16 as δ1, and the angle of inclination of the moderately inclined portion 16 as θ_{c}1, the length L_{c}1 of the moderately inclined portion 16 can be determined according to the following equation.
L_{c}1=δ1/θ_{c}1 (7)

The magnitude of the rolling element passage vibrations (pitching displacement of the slider) was determined in the constitution described above by numerical value simulation in a case of setting the slider side raceway surface length as: 80 mm, the rolling element diameter as: D_{W}=4 mm, the rolling element length as: 6 mm, the oversize amount of the rolling element as: δ₀=0.01 mm, the maximum reduction amount of the crowning as: δₘₐₓ=0.02 mm, the entire length of the crowning portion as: L_{ct}=L_{c}1+L_{c}2, the reduction amount of the moderately inclined portion as: δ1=0.005 mm, the reduction amount of the abruptly inclined portion as: δ2=δₘₐₓ−δ1=0.015 mm, the angle of inclination of the abruptly inclined portion as: θ_{c}2=δ2/L_{c}2, and the abruptly inclined portion length as: L_{c}2=2 mm, and changing the angle of inclination θ_{c}1 of the moderate inclination potion 16 to the slider side rolling element raceway surfaces 7 as within a range from 1/500 to 1/4000. FIG. 20 shows the result of calculation and relation with 1/θ_{c}1.

As apparent from FIG. 20, it can be seen that in a case where 1/θ_{c}1 is less than 2000, the pitching displacement increases abruptly but the pitching displacement is 0.5×10⁻⁵ rad or less when 1/θ_{c}1 is 2000 or more, preferably, 2400 or more. Accordingly, since the pitching displacement of the slider decreases by setting the angle of inclination θ_{c}1 of the moderately inclined portion 16 to 1/2000 or more, preferably, 1/2400 or more, the amplitude value of the rolling element passage vibrations can be suppressed to a small value.

Further, since the maximum reduction amount δₘₐₓ of the crowning portion 12 is defined as δₘₐₓ≧δ₀ in the embodiment described above, since the reduction amount of the crowning portion 12 can be ensured sufficiently, the slider can easily be assembled to the guide rail.

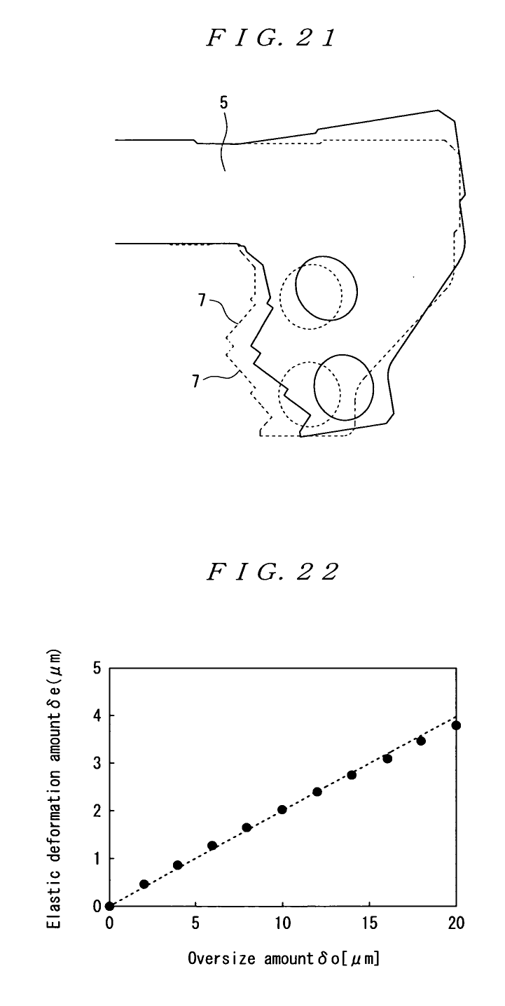

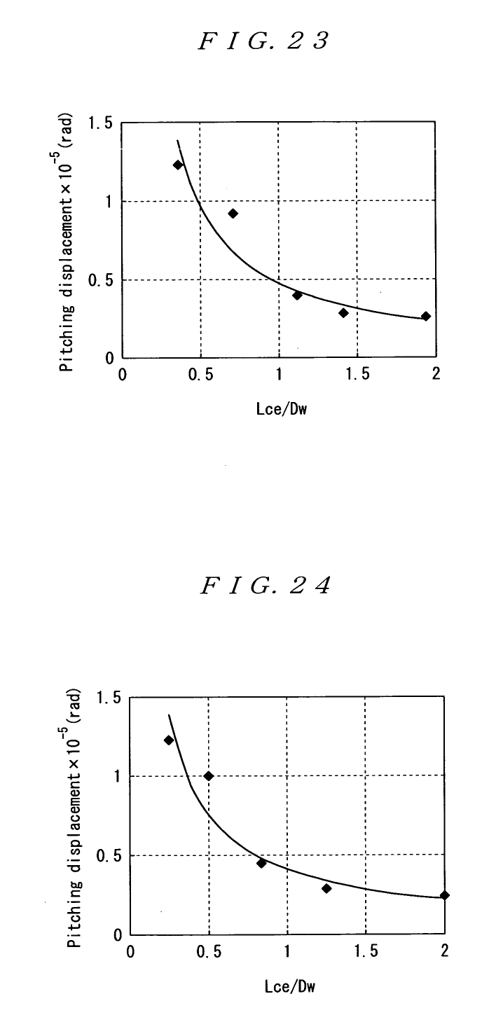

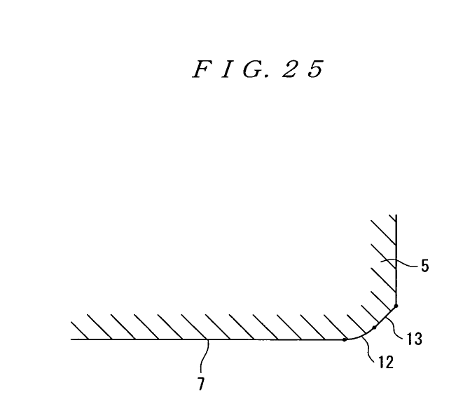

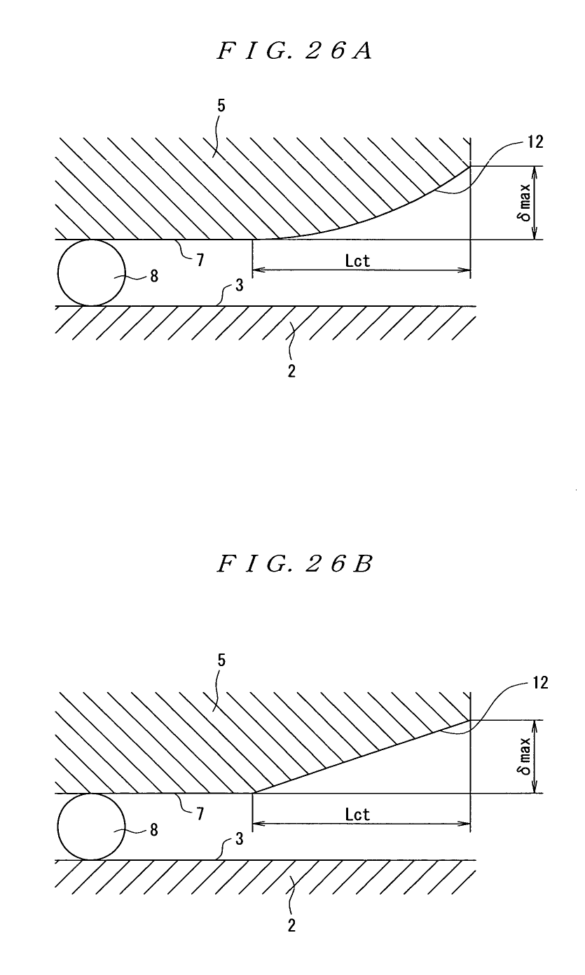

Assuming the effective length for the portion of the entire length of the crowning portion that undergoes load during use as L_{ce}, L_{ce} can be determined in a case where the crowing shape is an arcuate shape according to:
L_{ce}=√(2×δₑ×R_{c}1) (16)
and L_{ce} can be determined in a case where the crowing shape is linear shape according to;
L_{ce}=L_{c}1×δₑ/δ1 (17)
In this case, δₑ represents the elastic deformation amount of a rolling element during use which can be calculated by simultaneous calculation for the known relational expression of the rolling element load and the rolling element deformation amount, and the material deformation amount according to FEM, etc. For example, the load-displacement relation of the roller in this embodiment is in accordance with the Palmgron's equation (“Rolling Bearing Manual”, written by Eiichi Watabayashi, Japanese Standards Association, 1999). Further, the slider main body 5 deforms by the load undergoing from the rolling element as shown in FIG. 21. By taking the relations for both load-deformation amounts into consideration simultaneously, the relation between the oversize amount δ₀ of the roller and the elastic deformation amount δₑ of the roller assembled between the slider side rolling element raceway surfaces and the rail side rolling element raceway surfaces can be calculated. In this embodiment, the relation between δ₀ and δₑ is as shown in FIG. 22 and δ₀=10 μm, and δₑ=2 μm in FIG. 22.

FIG. 10 and FIG. 11 show the relation between the pitching displacement of the slider and L_{ce}D_{W} determined by the numerical value simulation described above. As apparent from the graphs, since the pitching displacement of the slider is decreased by defining the ratio of the effective length of the crowning portion relative to the diameter of the roller (L_{ce}/D_{W}) to 1 or more, preferably 1.2 or more, the amplitude value of the rolling element passage vibrations can be restricted to a small value.

The embodiment shown in FIG. 14 exemplifies a case where the moderately inclined portion 16 is of an arcuate shape and the abruptly inclined portion 15 is of a linear shape, but they may be of any other shape so long as the relation between the average angle of inclination θₐ1 (=δ1/L_{c}1) of the moderately inclined portion and the average inclination θₐ2 of the abruptly inclined portion (=δ2/L_{c}2) can satisfy a relation: θₐ1<θₐ2.

1. A linear guide apparatus comprising a guide rail,
a slider including a slider main body having rolling element raceway surfaces opposed to rolling element raceway surfaces formed on the guide rail along the longitudinal direction of the rail and rolling element return channels penetrated in the longitudinal direction of the guide rail, and end caps having communication channels for communication of the rolling element return channels and rolling element loading rolling channels formed between the rolling element raceway surfaces of the guide rail and the slider main body, and a plurality of rollers that roll along the rolling element loading rolling channels, the rolling element return channels, and the communication channels, wherein
the slider main body has chamfered portions inclined obliquely to the slider side rolling element raceway surfaces at both longitudinal end portions of the slider side rolling element raceway surfaces, and
the chamfered portions and the slider side rolling element raceway surfaces are formed by grinding a boundary portion between the slider side rolling element raceway surfaces and the chamfered portions into an arcuate shape, and are connected smoothly by way of curved surface portions with a ratio of radius of curvature relative to the diameter of the roller being 0.02 or more.

2. A linear guide apparatus according to claim 1, wherein the chamfered portions are formed to both longitudinal end portions of the slider side rolling element raceway surfaces at an angle of inclination of 10° or more and 45° or less relative to the slider side rolling element raceway surfaces.

3. A linear guide apparatus according to claim 1, wherein the curved surface portions are formed after grinding the slider side rolling element raceway surfaces or simultaneously with grinding for the slider side rolling element raceway surfaces.

4. A linear guide apparatus according to claim 1, wherein the slider main body has crowning portions formed by fabricating both longitudinal end portions of the slider side rolling element raceway surfaces such that each of the both longitudinal end portions of the rolling element loading rolling channels is gradually diverged toward the communication channels.

5. A linear guide apparatus comprising a guide rail
a slider including a slider main body having rolling element raceway surfaces opposed to rolling element raceway surfaces formed on the guide rail along the longitudinal direction of the rail and rolling element return channels penetrated in the longitudinal direction of the guide rail, and end caps having communication channels for communication of the rolling element return rolling channel and rolling element loading rolling channels formed between the rolling element raceway surfaces of the guide rail and the slider main body, and
a plurality of rollers that roll along the rolling element loading rolling channels, the rolling element return channels, and the communication channels, wherein
the slider main body has crowning portions on both longitudinal end portions of the slider side rolling element surfaces, the crowning portions respectively includes an abruptly inclined portion that inclines greatly to the slider side rolling element surfaces and a moderately inclined portion formed between the abruptly inclined portion and the slider side rolling element surfaces, and the crowning portions have a ratio of the effective length relative to the diameter of the roller being 1 or more.

6. A linear guide apparatus according to claim 5, wherein the moderately inclined portion is formed at a radius of curvature with the ratio relative to the diameter of the rollers of 1000 or more between the abruptly inclined portion and the slider side rolling element raceway surfaces.

7. A linear guide apparatus according to claim 5, wherein the moderately inclined portion is formed at an angle of inclination with a gradient of 1/2000 or less relative to the slider side rolling element raceway surfaces between the abruptly inclined portion and the slider side rolling element raceway surfaces.

8. A linear guide apparatus according to claim 5, wherein the abruptly inclined portion has a ratio of length relative to the diameter of the rollers of 0.5 or more.
